(19) United States
(12) Patent Application Publication
(10) Pub. No.: US 2002/0161739 A1
(43) Pub. Date: Oct. 31, 2002

(54) Multimedia contents providing system and a method thereof

(76) Inventor: Byeong-Seok Oh, Seoul (KR)

Correspondence Address: George C Beck, Foley & Lardner, Washington Harbour, 3000 K Street NW Suite 500, Washington, DC, 20007-5109, US

(21) Appl. No.: 09/959,326

(22) PCT Filed: Feb. 23, 2001
(86) PCT No.: PCT/KR01/00272

(30) Foreign Application Priority Data
Feb. 24, 2000 (KR) 2000-009130

(51) Int. Cl. G06F 7/00

(52) U.S. Cl. 707/1

(57) ABSTRACT

The present invention provides a video-on-demand system providing multimedia contents which activates advertising contents by detecting a break pointer, wherein the break pointer is included in the main multimedia contents. According to the present invention, it is easily performed to insert various kind of advertisements while the main content is played, so that the inserted advertisements are selected according to the playing time of the main content, the viewer information such as age, job, home address, etc.

### TITLE OF THE INVENTION

A Multimedia Contents Providing System and a Method thereof

### TECHNICAL FIELD OF THE ART

The present invention relates to a multimedia contents providing system and especially to a multimedia contents providing system for providing various kinds of multimedia contents by associating them.

### BACKGROUND OF THE INVENTION

Technologies about Video On Demand (“VOD”) system or Audio On Demand (“AOD”) system are well known in the art. According to the conventional VOD or AOD system, a viewer can enjoy watching or listening desired multimedia contents at a desired time by connecting to a content provider's server system, which can provide video or audio contents, with his/her client device, such as a television set-top box or a personal computer, connected to a network and selecting at least one of the video or audio contents which can be provided by the content provider's server.

The above described conventional content provider stores video or audio contents (“multimedia contents”) into a storage device of the server by digitalizing the multimedia contents, and then provides the digitalized multimedia contents through a network, where a digital communication is available, in the form of a digital data stream. According to the recent rapid development of digital data communication technology, digital data transfer rate is greatly increased, while the amount of transferred data is decreased as compression rate is increased. Therefore, it is expected so-called Contents On Demand system is commercialized in the near future.

According to the conventional system, the content provider charges a predetermined price for each and every multimedia content provided. However, the price per content is relatively high compared to the contents provided by broadcasting companies or cable network companies, and the competitions against them are not promising.

As for one conventional solution for this problem, the content provider inserts commercial advertisements before, after or while the selected multimedia content is provided. However, viewers seem so reluctant to watch advertisements before their multimedia contents start that the effect of advertisements could be even negative. Further, advertisements played after the multimedia contents have little effect because viewers generally do not watch them. Therefore, most effective method for advertising is inserting advertisements while each of the multimedia contents selected by the viewers (also called as “main contents”) is being played (hereinafter, this method is called as “intermediate advertisement”). According to the conventional intermediate advertisement method for inserting the advertisement while the main content is being played, each of the main contents must be edited to include advertisements which are played at a desired time. This kind of editing task takes a lot of time and effort, and when the advertisements are updated, the whole contents must be re-edited to include new advertisements. Further, it is impossible for the conventional VOD or AOD system to change inserted advertisements according to playing parameters, such as playtime, viewer information, viewer location, etc., of the selected multimedia contents.

### DETAILED DESCRIPTION OF THE PRESENT INVENTION

### BRIEF DESCRIPTION OF THE PRESENT INVENTION

The present invention was made to improve above described conventional systems or method, it is an object of the present invention to provide various kind of advertisement contents independently to one another according to playing parameters, such as playtime, viewer information, viewer location, etc., of the multimedia contents and to easily update the advertisement contents to be provided to viewers by providing a multimedia contents providing system and method which can insert advertisement contents while a main content is being played.

In order to achieve above and other objects, the present invention provides a multimedia content providing system for providing a multimedia content which is selected by a viewer through a communication network including: a first memory for storing at least one multimedia content in a digital data stream format, the multimedia content including a break pointer at a predetermined position thereof; a second memory for storing at least one advertisement content in a digital data stream format as a separate file from the multimedia content, the advertisement content being activated by the break pointer of the multimedia content and played during playing of the multimedia content; and a server for retrieving at least selected one of the multimedia contents from the first memory according to the viewer's selection and providing the retrieved multimedia content to the viewer through the communication network, wherein the server stops retrieving the multimedia content and starts retrieving one of the advertisement content when the break pointer is detected during retrieving of the multimedia content.

Further, the present invention also provides a multimedia content providing method for providing a multimedia content which is selected by a viewer through a communication network including steps of: storing at least one multimedia content in a digital data stream format, the multimedia content being provided to the viewer according to the viewer's selection; inserting a break pointer into the multimedia content including at a predetermined position thereof; storing at least one advertisement content in a digital data stream format as a separate file from the multimedia content, the advertisement content being activated by the break pointer of the multimedia content and played during playing of the multimedia content; retrieving at least selected one of the multimedia contents according to the viewer's selection and providing the retrieved multimedia content to the viewer through the communication network; and stopping retrieval of the multimedia content and retrieving one of the advertisement content when the break pointer is detected during retrieving of the multimedia content.

### BRIEF DESCRIPTION OF THE DRAWINGS

FIG. 1 is a schematic block diagram of an example of devices for a multimedia contents providing system according to the present invention.

FIG. 2a is a schematic diagram of an example of data format of a multimedia content according to the present invention.

FIG. 2b is a schematic diagram of an example of break point data of a multimedia content according to the present invention.

FIG. 3a is a flow chart of an embodiment of the multimedia contents providing method according to the present invention.

FIG. 3b is a flow chart of another embodiment of the multimedia contents providing method according to the present invention.

FIG. 4a is a schematic block diagram of an embodiment of the multimedia contents providing system according to the present invention.

FIG. 4b is a schematic block diagram of another embodiment of the multimedia contents providing system according to the present invention.

### PREFERRED EMBODIMENTS

By referring to the attached drawings, preferred embodiments and operations of the present invention are described in detail.

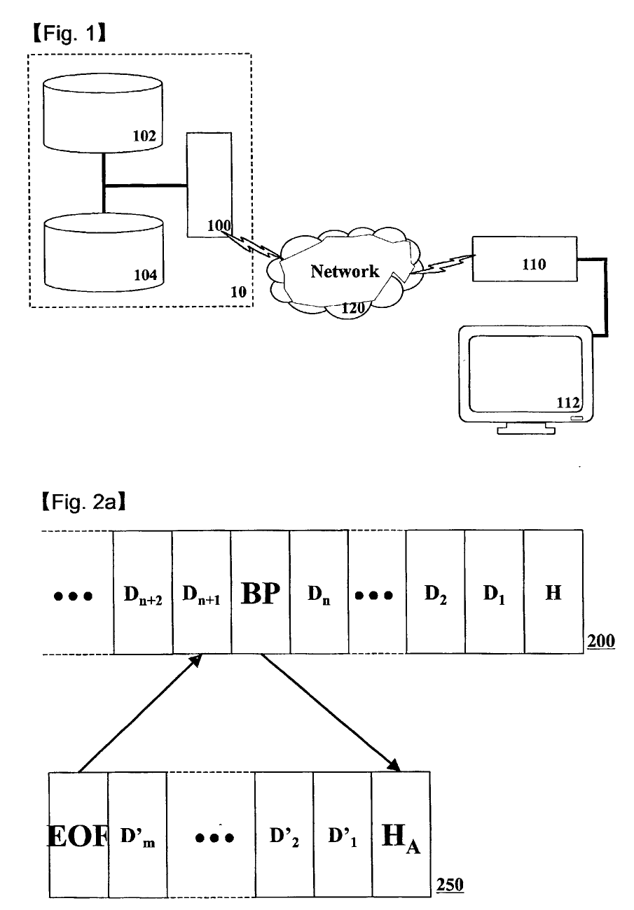

FIG. 1 is a schematic block diagram of an example of devices for a multimedia contents providing system according to the present invention. The multimedia contents providing system 10 of the present invention includes a server 100 connected to a communication network 120 and a first and second memories 102 and 104 maintained by the server 100. The first memory 102 stores one or more of multimedia contents having conventional digital data stream format. The second memory 104 stores one or more of advertisement contents, ordered from a sponsor, also having conventional digital data stream format.

An ordinary skilled person in the art of the present invention can readily recognize that the first and second memories 102 and 104 may be embodied in a hardware device and that they are not necessarily have logically different identifications. This is because, as described in detail below, both the multimedia contents and advertisement contents are in the form of files readable by a computer system. The only requirement of the multimedia contents and advertisement contents to be used for the present invention is to have independent accessibility by a computer system. Therefore, it is not required for the first and second memories 102 and 104 to be located outside of the server 100 as shown in FIG. 1. The above described software or hardware technologies are already well known in the art, and more detailed descriptions about these technologies can be omitted.

The server 100 may be a computer system which can be connected to the communication network 120, display a list of available multimedia contents to a viewer, receive a selection of the viewer and provide at least one multimedia content to the viewer according to the selection of the viewer by accessing the first memory 102. Therefore, almost all kind of computer system used for conventional VOD or AOD system can be used as the server 100 of the present invention.

The server 100 transfers a multimedia content from the first memory 102 according to the viewer's selection and detects retrieval of a break pointer (described in detail below) included in data stream of the multimedia content being transferred. If a break pointer is detected, the server 100 stops transfer of the multimedia content, and retrieve and transfer one or more of advertisement contents from the second memory 104. After transfer of the advertisement content(s) is(are) completed, the server resumes retrieval of the multimedia content and transfer data streams of the multimedia content after the break pointer. In other words, when the server 100 detects a break pointer included in data stream of a multimedia content, the server 100 temporarily stops transfer of the multimedia content, provides an advertisement content and then resumes transfer of the multimedia content.

The above described operation of the server 100 can be embodied by a simple software programmed using conventional file retrieval operation of a computer system. An operator of the multimedia content providing system of the present invention can insert advertisement while a main multimedia content is played only by placing a break pointer at a desired location of the main multimedia content.

The present invention is not limited to a case when a multimedia content is displayed on a viewer's display device 112 of the client 110 by decoding the multimedia content when the multimedia content is received. The present invention can be applicable to a case when the multimedia content is played at a viewer's desired time after the client 110 has stored whole data stream of the multimedia content because, once the server 100 detects a break pointer during retrieving the multimedia content, the advertisement content is retrieved and transferred by the server 100 to the client 110.

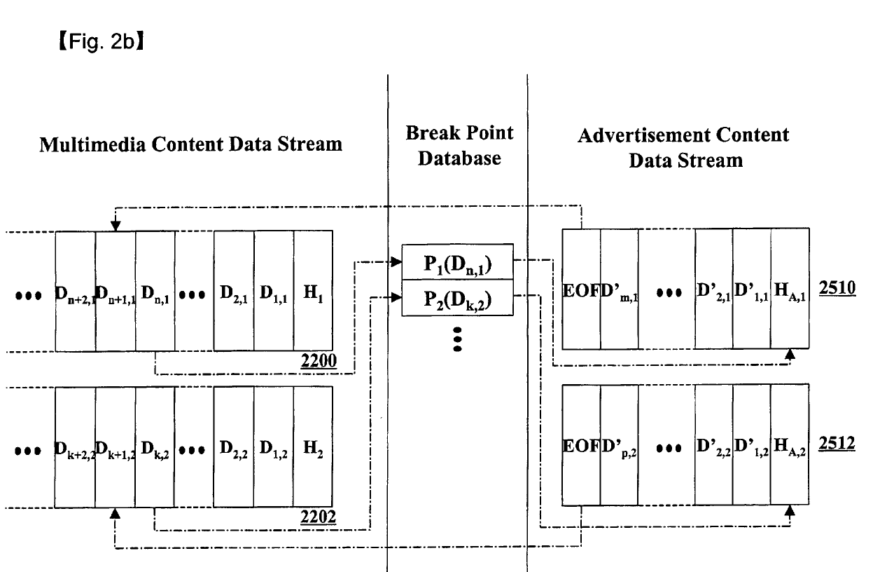

Now, referring to FIG. 2a, data format of a multimedia content and an advertisement content is described in detail.

FIG. 2a is a schematic diagram of an example of data format of a multimedia content according to the present invention. The multimedia content may be produced as digital content from the beginning, or originally produced as conventional analog content (i.e. video or audio content recorded on a magnetic cassette tape) and then converted as digital content. The multimedia content as digital content may be a data stream compressed according to a compression algorithm such as MPEG-4. The data stream 200 is shown in FIG. 2a.

As shown in FIG. 2a, the data stream 200 of the multimedia content may include a header according to the applied compression algorithm or production method. Next, the data stream 200 may further include image or audio information data D₁, D₂, . . . Dₙ retrieved from the first memory 102 under the control of the server 100. The server 100 transfers the retrieved data D₁, D₂, . . . Dₙ to the client 110 through the network 120, and the client 110 receives and decodes the transferred data, and display them on the display device 112.

The data stream 200 D₁, D₂, . . . Dₙ may be retrieved by a predetermined unit, for example, by the bit, by the packet or by the block, according to the type of the server 100, the type of the multimedia being retrieved, or the type of the compression algorithm used, etc.

While the multimedia content 200 is being retrieved, the break pointer BP included in the multimedia content 200 by an operator is retrieved at a predetermined moment. According to the embodiment shown in FIG. 2a, after the n-th data (or data packet) Dₙ is retrieved, the break pointer BP is retrieved. In response to the retrieval of the break pointer BP, the server 100 stops transferring (or retrieving) the multimedia content 200 being transferred (or retrieved), and starts retrieving the advertisement content 250 from the second memory 104, and then transfers the retrieved advertisement content 250 to the client 110. The break point BP may be formed in any kind of data format only if it can be uniquely identified from the data (or data packet) D₁, D₂, . . . Dₙ of the multimedia content 200. The format of the break pointer can be selected by the operator according to the type of the server 100, the type of the multimedia being retrieved, or the type of the compression algorithm used, etc.

For example, in case the multimedia content 200 is formed in a conventional mono-type wave file format, the break pointer can be embodied by inserting “extraordinary” consecutive two bytes, such as (FF)(00), at a predetermined position on the multimedia content 200. The occurrence of these two bytes, (FF)(00) is “extraordinary” in that each of them represents the loudest or the lowest sound and this kind of sound reproduction pattern, that is the lowest sound is reproduced just after the loudest sound is reproduced, is “extraordinarily” rare in reproducing a general sound file. Therefore, it is possible to program the sever 100 to recognize that a break pointer BP is retrieved when the “extraordinary” two bytes, (FF)(00), are retrieved.

For another example, in case the multimedia content 200 is uncompressed moving picture file format, the break pointer can be embodied by inserting consecutive three frames, which respectively have their own unique data bytes, such as (00), (FF) and (00), at a predetermined position on the multimedia content 200. The amount of data bytes included in a frame may vary according to the format or type of the multimedia content. In the uncompressed moving picture file format, the frames having data bytes of (00) and (FF) may respectively represent a “white-colored” and a “black-colored” frame. Therefore, if the consecutive three frames respectively having data bytes of (00), (FF) and (00) are retrieved, image of the reproduced moving picture may show an abrupt transition from white-colored image to black and then to white again. This kind of abrupt color transition is very rare in a general moving picture. Therefore, the server 100 can also be programmed to recognize this is a break pointer BP.

Of course, a break pointer BP does not necessarily have the same amount of data bytes corresponding to amount of three frames, and the amount of data bytes of a break pointer may vary according to the format and type of the multimedia contents as described above.

The operator may insert the above described break pointer at a most desirable position on the multimedia content 200 according to his own decision during previewing the multimedia content 200. The insertion of the break pointer can be easily performed by using a user interface programmed on the server 100. For example, a conventionally used software program, such as Hexa Editor (tm), or a multimedia content player, can be used to insert the break pointer in the multimedia content 200. The present invention is most effective for the intermediate advertisement, but if the break pointer is located just after the header H of the multimedia content data stream 200, the present invention also can be used for the “starting advertisement”, and if the break pointer is located just before the end of file (“EOF”) data of the multimedia content data stream 200, the present invention further can be used for the “ending advertisement”.

If the second memory 104 includes two or more of advertisement contents, the server 100 can be programmed to select one of the plurality of advertisement contents based on a predetermined criterion (criteria) when it detects the retrieval of the break pointer BP. For example, if the multimedia content selected by the user has a story for preschool children, the server may be programmed to select an advertisement content on clothes for the preschool children. Alternatively, if the playing time of the selected multimedia content designated by the user is in midnight, an advertisement content for adults only can be selected. Or, an advertisement content of a specific local sponsor can be selected if the user selecting a multimedia content lives in the same area with the sponsor, so that the effect of advertisement can be maximized.

The advertisement content data stream 250 may include a header H_{A} in order that the server 100 can easily access to the advertisement content 250, which is selected according to the above described criterion (criteria), after the server 100 detects the retrieval of the break pointer BP. After the header H_{A}, the advertisement content 250 includes data stream D'₁, D'₂, . . . D'ₘ formed in the same format with those of the multimedia content 200. Further, the advertisement content 250 includes EOF at the end of it. Of course, it is preferable that the header H_{A} and EOF of the advertisement content 250 may not be transferred to the client 110 so that the received data stream is treated as one multimedia content by the client 110. Therefore, after the break pointer is detected, the server 100 may insert a frame(s) of black or white image (in case of video content) or silence (in case of audio content) for a predetermined period, i.e. 2 or 3 seconds before the selected advertisement content is retrieved.

After the advertisement content data stream 250 is completely transferred, the server 100 resumes transfer of the multimedia content 200. The resumption of transfer of the multimedia content 200 begins at the very next data (or data packet) Dₙ₊₁ of the break pointer BP. However, note that it is also possible that the resumption of transfer of the multimedia content 200 may begin at those data, which has been already transferred, located before the break pointer BP according to the format or type of the multimedia content 200. For example, in case of a moving picture data file compressed in the well-known MPEG2 standard, since the difference between the consecutive two frames is used as compression information, it is preferable that the resumption of data transfer begins at a data corresponding to a reference frame (so-called “I-Picture”) of a group-of-picture where the data retrieved before or after the retrieval of the break pointer BP is included. On the other hand, it may be possible to locate the break pointer BP between the groups-of-picture, but, in this case, it is difficult to precisely start playing the advertisement content at a predetermined desired point of the multimedia content. Therefore, in order to precisely start playing the advertisement content, it is preferable to allow the break pointer BP to be located in a group-of-picture. Further, since users generally have a tendency to watch again the previous portions played before the advertisement content, it may be preferable to intentionally transfer the data located before the break pointer BP once more.

According to another conventional method of RealNetwork Co. for transferring so-called “real audio” contents, the audio contents stored in the server 100 comprised of a plurality of audio blocks, every predetermined number of the audio blocks has a stop marker (“SM”) and an acknowledge marker (“AM”) is included between every pair of stop markers. Both of the stop marker SM and acknowledge marker AM are not allowed to be located in an audio block. When the server 100 detects the stop marker SM during transfer of the audio blocks, the server 100 stops transferring the audio block and waits for reception of the acknowledge marker AM sent from the client 110. If the acknowledge marker AM sent from the client 110 is received, then the server 100 resumes transfer of the audio block after the stop marker SM. If the server 100 again detects the stop marker SM, it again stops and waits for the reception of the acknowledge marker AM from the client 110. In this case, it is also preferable that the break pointer BP of the present invention is allowed to be located in an audio block. Note that, according to the present invention, the server 100 retrieves and transfers the advertisement content when the break pointer BP is detected regardless of the reception of the acknowledge marker AM, and when the advertisement content is completely transferred, the server 100 resumes transfer of the audio block where the break pointer BP of the present invention is included. In this case, though the resumption of the audio block may begin at a data next to the break pointer BP, it is also possible that a data located before the break pointer BP may be transferred to the client 110 once again. Of course, the server 100 may be programmed to retrieve the data located before the break pointer BP once again.

Now, referring to FIG. 2b, another embodiment of the present invention will be described in detail. As shown in FIG. 2b, according to this embodiment of the present invention, instead of inserting the break pointer BP in the multimedia content, a break point database is provided to store information (“break point data”) on a position of a multimedia content where the server 100 temporarily stops the retrieval of the multimedia content. The break point database may be embodied on the first or second memories 102 or 104, or an additional third memory (not shown). Alternatively, the server 100 may include the break point database in it memory device (not shown).

The break pint database may include one or more of break point data P₁ or P₂ corresponding to each of the multimedia content 2200 or 2202. For example, as shown in FIG. 2b, after the n-th data (D_{n, 1}) of the first multimedia content 2200 is retrieved, the retrieval of the first multimedia content 2200 is stopped and a first advertisement content 2510 is retrieved. The first break point data P₁ informs the server 100 of this information. After the first advertisement content 2510 is completely retrieved, the server 100 resumes retrieval of the first multimedia content 2200. The resumption of retrieval of the first multimedia content 2200 begins at the next data or the (n+1)-th data (D_{n+,1 1}) of the n-th data (D_{n, 1}) where the retrieval was stopped. The above description can be applied to the second multimedia content 2202, the second break point data P₂ and a second advertisement content 2512.

Further, different advertisement contents 2510 and 2512 may be retrieved corresponding to the different multimedia contents 2200 and 2202 after the server 100 temporarily stops retrieving one of the multimedia contents 2200 and 2202. The server 100, however, may be programmed to retrieve the same advertisement content 2510 or 2512 even though retrieved multimedia contents are different. Further, in this embodiment, the server 100 may also be programmed to select an advertisement content out of various advertisement contents according to various situations as described above.

There is no need to limit the format of the break point data P₁ or P₂ to a specific one. It can be selected by an ordinary skilled person in the art according to the type of the server 100 and/or the operating system for the server 100. For example, the break point data P₁ or P₂ may be a predetermined time from the start of playing a multimedia content 2200 or 2202 or a number of a specific frame of a multimedia content 2200 or 2202. The server 100 stops retrieving the multimedia content 2200 or 2202 at the time or the frame designated by the break pointer 2200 or 2202, and retrieves and transfers the designated or selected advertisement content 2510 or 2512. As in the case of the above described first embodiment, after the transfer of the advertisement content 2510 or 2512 is completed, the transfer of the multimedia content 2200 or 2202 is resumed based the position, where the transfer of the multimedia content 2200 or 2202 is stopped, as a reference.

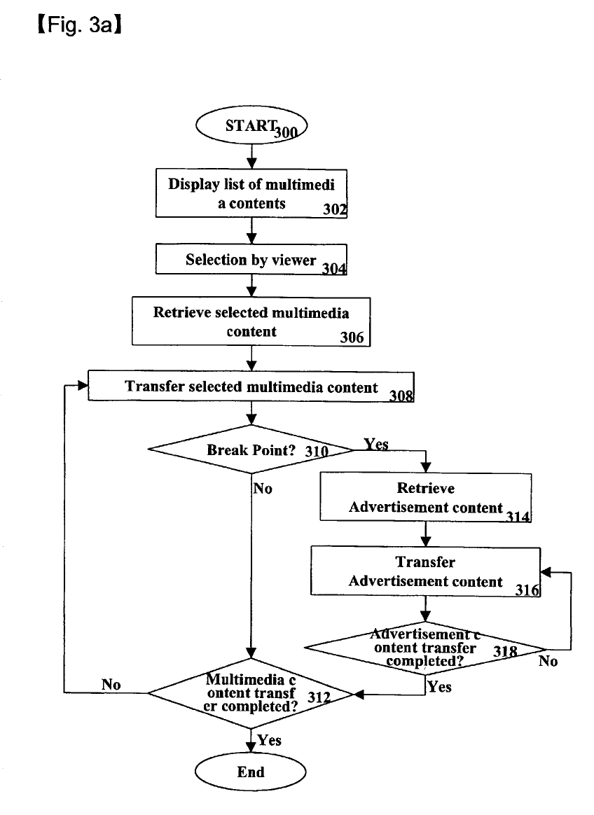

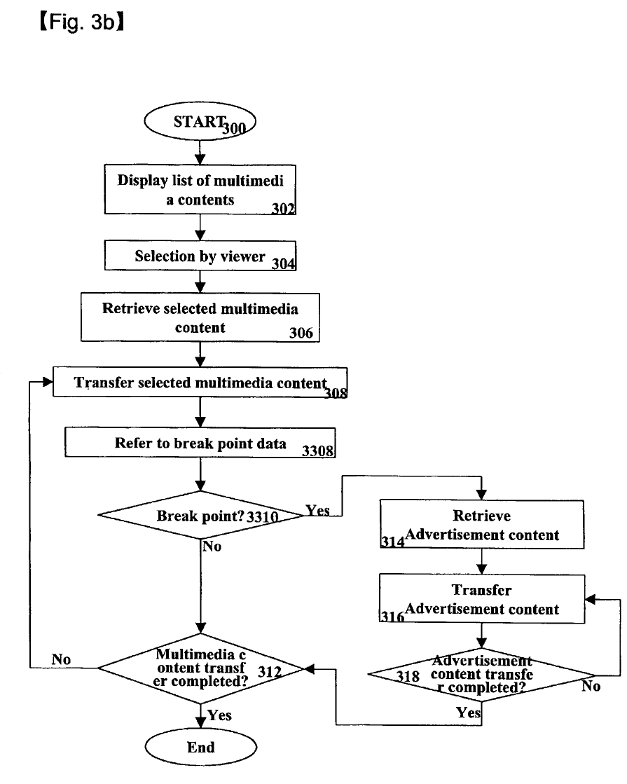

Now, referring to FIG. 3a, the operation of the multimedia content providing system 10 according to an embodiment of the present invention is described in detail. FIG. 3a is a flow chart of an embodiment of the multimedia contents providing method according to the present invention. As shown in the drawing, the operation is started at step 300 by a user connected to the server 100. Then, the server provides a list of available multimedia contents to the client 110 and the list is displayed on the display device 112 of the client 110 (step 302). The list of multimedia contents may be in the form of a plurality of thumbnails or video clips as well as listed texts.

Then, after the user selects a multimedia content to watch (step 304), the server 100 retrieves the selected multimedia content from the first memory 102 (step 306) and transfers the retrieved multimedia content to the client 110 (step 308). The server 100 determines if a break pointer BP is retrieved during the retrieval of the multimedia content (step 310), and if not, the server 100 continues to retrieve and transfer the multimedia content (step 312 and step 308).

However, if the break pointer BP is determined to be retrieved, the server stops retrieval of the multimedia content, and retrieves and transfers data stream of an advertisement content (step 314 and step 318). After the advertisement content is completely transferred, the server 100 resumes the retrieval and transfer of the multimedia content selected by the user (steps 312, 308 and 310). After the multimedia content is completely transferred, the operation of the server 100 is completed.

Now, referring to FIG. 3b, the operation of the multimedia content providing system 10 according to another embodiment of the present invention is described in detail. FIG. 3b is a flow chart of another embodiment of the multimedia contents providing method according to the present invention. Similar operation steps are designated by same reference numbers and the detailed descriptions thereof are omitted. As shown in drawing, the server 100 refers to the break point data i.e. P₁ assigned to each of the multimedia contents (step 3308) while it transfers the selected multimedia content (step 308). The server 100 determines if the retrieval of the multimedia content arrives at the break point designated by the break point data (step 3310). If it is determined that the retrieval does not arrive at the break point, the server 100 determines if the multimedia content is completely transferred (step 312). However, if it is determined at step 3310 that the retrieval of the multimedia content has arrived at the break point, the server 100 stops retrieving the multimedia content, and retrieves and transfers the designated or selected advertisement content (for example, advertisement content 2510 shown in FIG. 2b), to the client 110. Other operation steps are analogous to those shown in FIG. 3a.

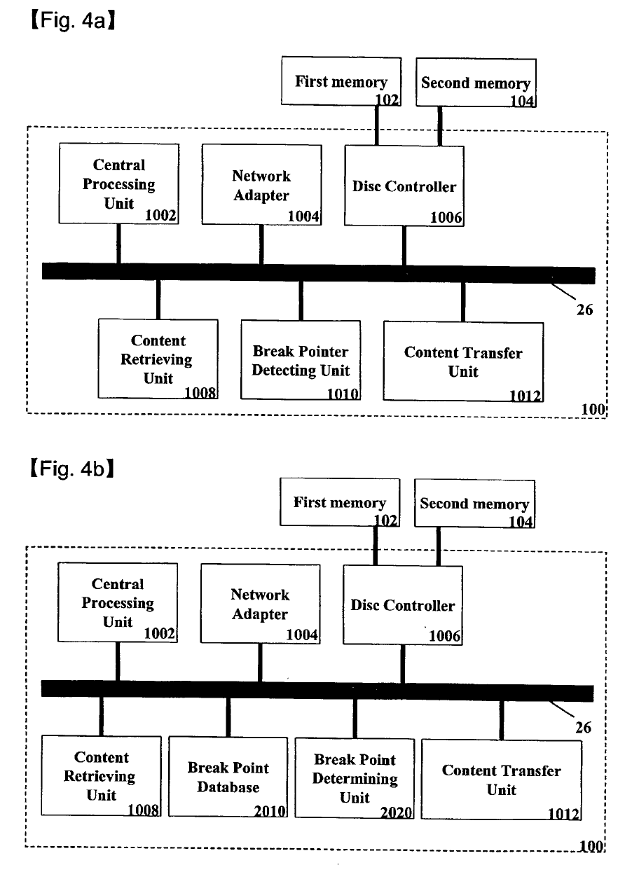

Now, referring to FIG. 4a, an embodiment of the multimedia content providing system according to the present invention is described in detail. FIG. 4a is a schematic block diagram of an embodiment of the multimedia contents providing system according to the present invention. As shown in drawing, the server 100 includes conventional hardware devices and software units like a central processing unit 1002, a network adapter 1004 and a disc controller 1006. The server 100 further includes softwares like interfacing applications for operators or viewers (users) and operating system software for these applications.

Further, the server 100 of the present invention includes a content retrieving unit 1008 for retrieving data stream of a multimedia content in response to the selection of the viewer (user), a break pointer detecting unit 1010 for detecting the break pointer BP from the retrieved data stream and a content transferring unit 1012 for transferring the retrieved data. The above units and other elements of the server 100 perform data communication with among others via a bus 26.

If the break pointer detecting unit 1010 detects the break pointer BP, it notifies the detection of the break pointer BP to the content retrieving unit 1008. The content retrieving unit 1008 received the notification controls the disc controller 1006 to stop retrieving the multimedia content and to retrieve the designated or selected advertisement content. The retrieved advertisement content is transferred to the client 110 under the control of the content transferring unit 1012 and the network adapter 100 through the communication network 120.

When the transfer of the advertisement content is completed, the content transferring unit 1012 again notifies this completion of transfer to the content retrieving unit 1008, and the content retrieving unit 1008 resumes retrieval of the multimedia content.

Now, referring to FIG. 4b, another embodiment of the multimedia content providing system according to the present invention is described in detail. FIG. 4b is a schematic block diagram of another embodiment of the multimedia contents providing system according to the present invention. Same elements are designated by the same reference numbers, and detailed description of the same or similar functions with those of the first embodiment are omitted. As shown in FIG. 4b, according to the second embodiment of the present invention, the server 100 includes a break point database 2010 for storing break point data (i.e. P₁ or P₂) designating the break point of each of the multimedia contents, and a break point determining unit 2020 for determining if retrieval of a multimedia content arrives at the break point by referring to the break point data instead of the break pointer detecting unit 1010 of the first embodiment. When the break point determining unit 2020 determines that the retrieval of the multimedia content has arrived at the break point designated by the break point data (i.e. P₁ or P₂), it notifies the content retrieving unit 1008 of this arrival. As in the case of the first embodiment, the content retrieving unit 1008 received this notification controls the disc controller 1006 to stop retrieving the multimedia content and to retrieve the designated or selected advertisement content. The retrieved advertisement content is transferred to the client 110 under the control of the content transferring unit 1012 and the network adapter 100 through the communication network 120. Other operations are the same with those of the first embodiment.

It should be noted that the above descriptions are examples of elements, operations or performances which can be embodied by the multimedia content providing system and method of the present invention, and that the present invention is not limited to what described here. Especially, the present invention can be preferably applied to the on-demand multimedia content providing services, but also can be applied to any type of multimedia content providing services only if the multimedia contents and advertisement contents provided are digitized.

### INDUSTRIAL APPLICATION

According to the present invention, the multimedia contents and advertisement contents can be separately stored in a memory or separate memories, so that memory utility efficiency is increased.

Further, according to the present invention, the time, cost and efforts for editing the multimedia contents to insert various advertisement contents into them can be drastically decreased.

Further, according to the present invention, since it is possible to select proper advertisement content to be inserted based on the nature of viewers or the available multimedia contents, the effectiveness of advertising is greatly increased.

1. A multimedia content providing system for providing a multimedia content which is selected by a viewer through a communication network comprising:
a first memory for storing at least one multimedia content in a digital data stream format, said multimedia content comprising a break pointer at a predetermined position thereof;
a second memory for storing at least one advertisement content in a digital data stream format as a separate file from said multimedia content, said advertisement content being activated by said break pointer of said multimedia content and played during playing of said multimedia content; and
a server for retrieving at least selected one of said multimedia contents from said first memory according to said viewer's selection and providing said retrieved multimedia content to said viewer through said communication network, wherein said server stops retrieving said multimedia content and starts retrieving one of said advertisement content when said break pointer is detected during retrieving of said multimedia content.

2. A multimedia content providing system as claimed in claim 1, wherein said server further comprises:
a content retrieving unit for controlling retrieval of data stream of said multimedia content according to said viewer's selection;
a break pointer detecting unit for detecting said break pointer from said retrieved data stream; and
a content transferring unit for controlling transfer of retrieved data stream.

3. A multimedia content providing system as claimed in claim 1, wherein said server resumes providing said multimedia content, of which retrieval has been stopped, after said advertisement content is completely provided.

4. A multimedia content providing system as claimed in any one of claims 1 to 3, wherein said server further comprises:
a first database for storing information of said multimedia content stored in said first memory; and
a second database for storing information of said advertisement content stored in said second memory, and
said content retrieving unit receives said information of said advertisement content stored in said second memory from said second database and selects at least one advertisement content which will be activated in response to detection of said break pointer in said data stream of said multimedia content which is selected by said viewer.

5. A multimedia content providing system as claimed in claim 4, wherein said server selects at least one advertisement content from said second memory according to information of said viewer's place, age or watching time and provides said selected advertisement content to said viewer.

6. A multimedia content providing system for providing a multimedia content which is selected by a viewer through a communication network comprising:
a first memory for storing at least one multimedia content in a digital data stream format;
a second memory for storing at least one advertisement content in a digital data stream format as a separate file from said multimedia content, said advertisement content being played during playing of said multimedia content;
a break point database for storing break point data on a break point of said multimedia content; and
a server for retrieving said multimedia content from said first memory according to said viewer's selection and providing said retrieved multimedia content to said viewer through said communication network, wherein said server stops retrieving said multimedia content and starts retrieving one of said advertisement content when retrieval of said multimedia content arrives at said break point.

7. A multimedia content providing system as claimed in claim 6, wherein said server further comprises:
a content retrieving unit for controlling retrieval of data stream of said multimedia content according to said viewer's selection;
a break point determining unit for determining if retrieval of a multimedia content arrives at said break point by referring to said break point data; and
a content transferring unit for controlling transfer of retrieved data stream.

8. A multimedia content providing system as claimed in claim 6, wherein said server resumes providing said multimedia content, of which retrieval has been stopped, after said advertisement content is completely provided.

9. A multimedia content providing system as claimed in any one of claims 6 to 8, wherein said server further comprises:
a first database for storing information of said multimedia content stored in said first memory; and
a second database for storing information of said advertisement content stored in said second memory, and
said content retrieving unit receives said information of said advertisement content stored in said second memory from said second database and selects at least one advertisement content which will be activated in response to a determination that retrieval of said multimedia content has arrived at said break point.

10. A multimedia content providing system as claimed in claim 9, wherein said server selects at least one advertisement content from said second memory according to information of said viewer's place, age or watching time and provides said selected advertisement content to said viewer.

11. A multimedia content providing method for providing a multimedia content which is selected by a viewer through a communication network comprising steps of:
storing at least one multimedia content in a digital data stream format, said multimedia content being provided to said viewer according to said viewer's selection;
inserting a break pointer into said multimedia content comprising at a predetermined position thereof;
storing at least one advertisement content in a digital data stream format as a separate file from said multimedia content, said advertisement content being activated by said break pointer of said multimedia content and played during playing of said multimedia content;
retrieving at least selected one of said multimedia contents according to said viewer's selection and providing said retrieved multimedia content to said viewer through said communication network; and
stopping retrieval of said multimedia content and retrieving one of said advertisement content when said break pointer is detected during retrieving of said multimedia content.

12. A multimedia content providing method as claimed in claim 11 further comprising a step of resuming providing said multimedia content, of which retrieval has been stopped, after said advertisement content is completely provided.

13. A multimedia content providing method as claimed in claim 11 or claim 12 further comprising steps of:
storing information of said multimedia content in a first database;
storing information of said advertisement content in a second database; and
selecting at least one advertisement content, which will be activated in response to detection of said break pointer in said data stream of said multimedia content selected by said viewer, by receiving said information of said advertisement content from said second database.

14. A multimedia content providing method as claimed in claim 13 further comprising steps of:
selecting at least one advertisement content according to information of said viewer's place, age or watching time; and
providing said selected advertisement content to said viewer.

15. A multimedia content providing method for providing a multimedia content which is selected by a viewer through a communication network comprising steps of:
storing at least one multimedia content in a digital data stream format, said multimedia content being provided to said viewer according to said viewer's selection;
determining a break point of said digital data stream of said at least one of multimedia content;
storing break point data of said break point in a break point database;
storing at least one advertisement content in a digital data stream format as a separate file from said multimedia content, said advertisement content being played during playing of said multimedia content;
retrieving at least selected one of said multimedia contents according to said viewer's selection and providing said retrieved multimedia content to said viewer through said communication network; and
retrieving one of said advertisement content when retrieval of said multimedia content arrives at said break point.

16. A multimedia content providing method as claimed in claim 15 further comprising a step of resuming providing said multimedia content, of which retrieval has been stopped, after said advertisement content is completely provided.

17. A multimedia content providing method as claimed in claim 15 or claim 16 further comprising steps of:
storing information of said multimedia content in a first database;
storing information of said advertisement content in a second database; and
selecting at least one advertisement content, which will be activated in response to a moment when retrieval of said multimedia content selected by said viewer arrives at said break point, by receiving said information of said advertisement content from said second database.

18. A multimedia content providing method as claimed in claim 17 further comprising steps of:
selecting at least one advertisement content according to information of said viewer's place, age or watching time; and
providing said selected advertisement content to said viewer.
